(19) United States
(12) Patent Application Publication
(10) Pub. No.: US 2021/0265689 A1
(43) Pub. Date: Aug. 26, 2021

(54) BATTERY

(71) Applicant: Panasonic Intellectual Property Management Co., Ltd., Osaka (JP)

(72) Inventors: KENJI YAMATO, Osaka (JP); TADAYOSHI TAKAHASHI, Osaka (JP)

(21) Appl. No.: 17/251,924

(22) PCT Filed: Jan. 15, 2019
(86) PCT No.: PCT/JP2019/000822

§ 371 Date: Dec. 14, 2020

(30) Foreign Application Priority Data
Jun. 21, 2018 (JP) 2018-117842

(51) Int. Cl. H01M 50/183; H01M 50/152; H01M 50/166; H01M 10/04

(52) U.S. Cl. CPC H01M 50/183; H01M 50/152; H01M 10/0525; H01M 10/0422; H01M 50/166

(57) ABSTRACT

A battery including a battery can including a cylinder portion, a bottom wall for closing a first end of the cylinder portion, and an opening edge continuous to a second end of the cylinder portion; a power generation element housed in the cylinder portion; and a sealing plate fixed to the opening edge so as to seal an opening of the opening edge. The sealing plate includes a lid portion, and a peripheral edge portion continuous to the lid portion, the opening edge and the peripheral edge portion are linked to each other by a double seaming structure, and 0.1 mm≤T1≤0.5 mm, 0.1 mm≤T2≤0.5 mm, 1.1≤T2/T1≤3.0, and −0.21T2+1.72T1≤X≤0.27T2+4.51T1 are satisfied, where X (min) is an overlap length of a body hook of the opening edge and a cover hook of the peripheral edge portion in the double seaming structure, T1 is a thickness of the body hook, and T2 is a thickness of the cover hook.

### TECHNICAL FIELD

The present invention relates to a battery including a battery can, a power generation element housed in the battery can, and a sealing plate for sealing an opening of the battery can.

### BACKGROUND ART

When an opening of a battery can is sealed by a sealing plate, in general, a diameter of a vicinity of the opening of the battery can is reduced inward to form an annular groove. A gasket is provided at a peripheral edge portion of the sealing plate. The gasket of the sealing plate is sandwiched between an end of the battery can and the annular groove, followed by being compressed in the vertical direction, and thus the sealing plate is fixed to the battery can (see, PTL 1).

Furthermore, an opening end of a battery can and a peripheral edge portion of a lid made of metal are laser-welded to each other to seal an opening of the battery can by the lid (see PTL 2).

However, with the method of PTL 1, a sealing part may be in sufficient in strength. With the method in PTL 2, since a laser apparatus is expensive, a manufacturing cost of the battery is increased.

Thus, forming a sealing part of the battery by a double seaming method has been proposed (see PTLs 3 and 4).

### CITATION LIST

### Patent Literature

PTL 1: Japanese Patent Application Unexamined Publication No. H7-105933

PTL 2: Japanese Patent Application Unexamined Publication No. 2017-195165

PTL 3: Japanese Patent Application Unexamined Publication No. H9-73885

PTL 4: Japanese Patent Application Unexamined Publication No. 2002-343310

### SUMMARY OF THE INVENTION

A double seaming method. is often employed in large cases such as a beverage can or an 18-liter square can including a thin container and a lid. While an internal pressure of the beverage can is less than 10 atm, the internal pressure of the battery is assumed to be high, for example, 60 atm or higher. Furthermore, a battery has high density, and therefore is susceptible to an impact such as dropping. In view of the above, when the double seaming method is employed for sealing a battery can with a sealing plate, it is difficult to reduce the thickness of material of a battery can and a sealing plate depending on a size even in the case of batteries having a general size.

On the other hand, when the double seaming method is employed for a battery, air-tightness or impact resistance of the sealing part tend to be reduced. The reduction of the air-tightness or the impact resistance is thought to be related to the point that processing of the sealing part becomes difficult due to, for example, a thickness of the material. Note here that in PTLs 3 and 4, a thickness of a battery lid having a large degree of processing is not more than a thickness of a battery container or a case main body.

A first aspect of the present invention relates to a battery including a battery can including a cylinder portion, a bottom wall for closing a first end of the cylinder portion, and an opening edge continuous to a second end of the cylinder portion; a power generation element housed in the cylinder portion; and a sealing plate fixed to the opening edge so as to seal an opening of the opening edge, wherein the sealing plate includes a lid portion, and a peripheral edge portion continuous to the lid portion, the opening edge and the peripheral edge portion are linked to each other by a double seaming structure, and the following relation formulae (1) to (4) are satisfied where X millimeter(mm) is an overlap length of a body hook of the opening edge and a cover hook of the peripheral edge portion in the double seaming structure, T1 is a thickness of the body hook, and T2 is a thickness of the cover hook.

0.1 mm≤T1≤0.5 mm (1)

0.1 min≤T2≤0.5 mm (2)

1.1≤T2/T1≤3.0 (3)

−0.21.T2+1.72T1≤X≤0.27T2+4.51T1 (4)

According to the present invention, the airtightness and the impact resistance of the sealing part of the battery having the double seaming structure are improved.

### BRIEF DESCRIPTION OF DRAWINGS

FIG. 1 is a schematic longitudinal sectional view of a battery in accordance with one exemplary embodiment of the present invention.

FIG. 2 is a view to illustrate a double seaming structure of a sealing part of the battery.

FIG. 3 is a view to illustrate a double seaming structure of a sealing part of another battery.

FIG. 4 is a view to illustrate an example of a manufacturing method of a battery having a double seaming structure, showing a battery can preparation step (a), a necking step (h), a flanging step (c), a sealing plate disposing step (d), a first seaming step (e), and a second seaming step (f).

FIG. 5 is a view showing a relation between. T2/T1 and X/T1.

FIG. 6 is a view showing a relation between T2/T1 and X/T1 for Examples and Comparative Examples, respectively.

FIG. 7 is a view to illustrate a double seaming structure in accordance with another exemplary embodiment of the present invention.

### DESCRIPTION OF EMBODIMENTS

A battery according to this exemplary embodiment includes a battery can including a cylinder portion, a bottom wall for closing a first end of the cylinder portion, and an opening edge continuous to a second end of the cylinder portion; a power generation element housed in the cylinder portion; and a sealing plate fixed to the opening edge so as to seal an opening of the opening edge. The sealing plate includes a lid portion, and a peripheral edge portion continuous to the lid portion. The opening edge and the peripheral edge portion are linked to each other by a double seaming structure. The following relation formulae (1) to (4) are satisfied where X (mm) is an overlap length of a body hook of the opening edge and a cover hook of the peripheral edge portion in the double seaming structure, T1 is a thickness of the body hook, and T2 is a thickness of the cover hook.

0.1 mm≤T1≤0.5 mm (1)

0.1 mm≤T2≤0.5 mm (2)

1.1≤T2/T1≤3.0 (3)

−0.21T2+1.72T1≤X≤0.27T2+4.51T1 (4)

According to the above configuration, the airtightness and the impact resistance of the sealing part of the battery having a double seaming structure are improved. Herein, the sealing part is a site having a double seaming structure formed of the opening edge of the battery can and the peripheral edge portion of the sealing plate. When the impact resistance of the sealing part becomes insufficient, the sealing part is deformed, and, for example, the outer diameter of the battery may exceed a reference value. In that case, it may he difficult to install a battery to a device to be used. Furthermore, when the impact resistance of the sealing part is low, the air-tightness is easily deteriorated., and thus liquid leakage may occur.

Herein, the double seaming structure is a tightly closed structure in which the peripheral edge portion of the sealing plate and the opening edge of the battery can are wound in and tightened to each other. In the double seaming structure, a body hook formed of an extreme end of the opening edge and a cover hook formed of an outermost peripheral portion of the peripheral edge portion of the sealing plate are engaged into each other. Hereinafter, a series of steps for forming the double seaming structure are referred to as double seaming processing.

The cylinder portion of the battery can is a main site having the same inner diameter in the battery can. The opening edge is a site between a diameter-reduction starting position at an opening side in which bending starts from the main site and the extreme end. The bottom wall is a site between a bending starting position at the closing side in which bending starts from the main site and the lowermost end.

The relation formula (1): 0.1 mm≤T1≤0.5 mm and the relation formula (2): 0.1 mm≤T2≤0.5 mm define the ranges of a thickness T1 of the body hook and a thickness T2 of the cover hook. The internal pressure of the battery may become as high pressure as 60 atm or more. Furthermore, a battery having a high density is susceptible to an impact such as dropping. In order to prevent the sealing part from being deformed at the time when the internal pressure is raised and an impact is applied, the thicknesses of the body hook and the cover hook constituting the sealing part need to be 0.1 mm or more. On the other hand, when each of T1 and T2 is more than 0.5 mm, the double seaming processing becomes difficult. As a result, uniformity of the sealing part is reduced, and the air-tightness is reduced, or the sealing part is easily deformed partially.

In batteries (for example, D, C, AA, and AAA batteries) having high versatility and relatively small sizes (for example, the outer diameter is 50 mm or less or 40 mm or less), T1 may satisfy 0.1 mm≤T1≤0.3 mm, and 0.1 mm≤T1≤0.25 mm.

Similarly in batteries having high versatility and relatively small sizes as mentioned above, T2 may satisfy 0.11 mm≤T2≤0.45 mm, and may satisfy 0.15 mm≤T1≤0.45 mm.

In such batteries having high versatility and relatively small sizes as mentioned above, it is desirable to reduce the size of the sealing part and to increase the capacity density per volume as compared with a beverage can or the like. For a distance d1 between an upper end. of the double seaming structure, referred to as a seaming panel, and a lower end of the double seaming structure, referred to as a cover hook radius, for example, 0.6 mm to 1.7 mm is sufficient, and the distance d1 may be 0.8 mm to 1.5 mm. Furthermore, for a distance d2 between the lower end of the double seaming structure and the uppermost portion of the lid portion, for example, 0.0 mm to 3.0 mm is sufficient, and the distance d2 may be 1.0 mm to 2.0 mm.

It is difficult to secure the air-tightness and the impact resistance only when the relation formulae (1) and (2) are satisfied. It is further necessary to satisfy the relation formula (3): 1.1≤T2/T1≤3.0. When the relation formula (3) is satisfied, the thickness T2 of the cover hook is sufficiently larger than the thickness T1 of the body hook, and the strength of the sealing plate is relatively improved with respect to that of the opening edge of the battery can. Furthermore, the peripheral edge portion of the sealing plate has a three-layer structure including a cover hook, a seaming wall, and a chuck wall. Thus, when the strength of the sealing plate is improved, the strength of the entire sealing part including the opening edge of the battery can is remarkably improved. On the other hand, the opening edge of the battery can including a body hook having a smaller thickness T1 has an effect of relieving an impact. When the improvement of the strength of the sealing part and relieving of an impact act synergistically in this way, the deformation of the sealing part when the battery receives the impact is easily suppressed.

Note here that when a T2/T1 ratio is more than 3.0, a difference of workability by a difference of the thickness between the cover hook and the body hook is excessively increased, thus making well-balanced double seaming processing difficult. Then, the uniformity of the sealing part is deteriorated, and air-tightness is deteriorated or the sealing part is easily deformed partially. Furthermore, when the T2/T1 ratio is less than 1.1, it becomes difficult to secure the impact resistance, a distance between the inside surface of the seaming wall and the inside surface of the chuck wall becomes relatively large. Thus, small gaps are easily generated, and consequently the air-tightness of the battery becomes easily deteriorated.

From the viewpoint of further facilitating the double seaming processing, 1.4≤T2/T1≤2.6 may be satisfied, or 1.5≤T2/T1≤2.5 may be satisfied.

In order to secure the air-tightness and. the impact resistance of the sealing part, it is further necessary to satisfy the relation formula (4): −0.21T2+1.72T1≤X≤0.27T2+4.51T1 in addition to the relation formulae (1) to (3). The relation formula (4) represents relation between a ratio (X/T1 ratio) of an overlap length X (mm) of the body hook and the cover hook to the thickness T1 of the body hook, and the T2/T1 ratio. By controlling the relation between the X/T1 ratio and the T2/T1 ratio, well-balanced double seaming processing can be performed, uniformity of the sealing part is remarkably improved, and the air-tightness and the impact resistance of the sealing part are remarkably improved. When the X/T1 ratio becomes too large (that is, X>0.27T2+4.51T1), and when the relation formula (4) is not satisfied, the double seaming processing becomes difficult, and uniformity of the sealing part is deteriorated. Furthermore, when the X/T1 ratio becomes too small (that is, X<−0.21T2+1.72T1), and when the relation formula (4) is not satisfied, the air-tightness of the sealing part is rapidly deteriorated.

X, T1, and T2 may further satisfy the relation formula (5): −0.21T2+1.72T1≤X≤−0.19T2+4.53T1. In batteries (for example, D, C, AA, and AAA batteries) having high versatility and relatively small sizes, as X becomes larger, the degree of increase in difficulty of the double seaming processing is increased. On the contrary, when the relation formula (5) is satisfied, more favorable double seaming processing can be performed while a sufficiently large X value is secured.

The density of the battery is, for example, 1.5 g/cm³ or more. The density of the battery is obtained by dividing a mass of the entire battery by a volume of the entire battery. The mass of the entire battery is mass of the all of the battery can, the power generation element, and the sealing plate, and may include an outer packaging label and the like. For example, the density of a dry battery is about 2.5 g/cm³ to 3.6 g/cm³, and the density of a lithium primary battery having high weight energy density is about 1.5 g/cm³ to 2.5 g/cm³. On the other hand, in the case of, for example, a beverage can including a beverage, since the density of beverage is about 1 g/cm³ to 1.3 g/cm³, the density of an entire beverage can including a beverage does not exceed 1.5 g/cm³.

T1, T2, and the outer diameter D (mm) of the cylinder portion satisfy, for example, the following relation formula (6): 0.01≤(T1+T2)/D)≤0.06. T1 and T2 approximately reflect the thicknesses of materials of a battery can and a sealing plate. That is to say, when the formula (6) is satisfied, the total thickness of the material of the battery can and the sealing plate approximately corresponds to 1% to 6% of the outer diameter D of the cylinder portion. The batteries having high versatility and relatively small sizes may satisfy 0.015≤(T1+T2)/D≤0.05, and may satisfy 0.02<(T1+T2)/D≤0.05.

A thickness T3 of the cylinder portion may be substantially the same as T1, but T3 may be smaller than T1. T1 may be 1.1 times or more as large as T3. Thus, even when the material of the battery can is relatively thin, the strength of the sealing part is easily increased.

For materials of the battery can and the sealing plate, metal is sufficient. Examples of the metal include iron, an iron alloy, stainless steel, a nickel alloy and the like. The materials may be plated in order to improve the corrosion resistance.

In order to enhance the airtightness of the sealing part, a sealing agent (sealant) may be interposed between the peripheral edge portion of the sealing plate and the opening edge of the battery can. The sealing agent may be interposed, for example, between the body hook and the cover hook, but it is preferable that the sealing agent is applied to as large area as possible in the peripheral edge portion of the sealing plate and the opening edge of the battery can. Examples of the sealing agent include adhesive agents such as asphalt, rubbery resin such as butyl rubber, a polyamide resin, and the like.

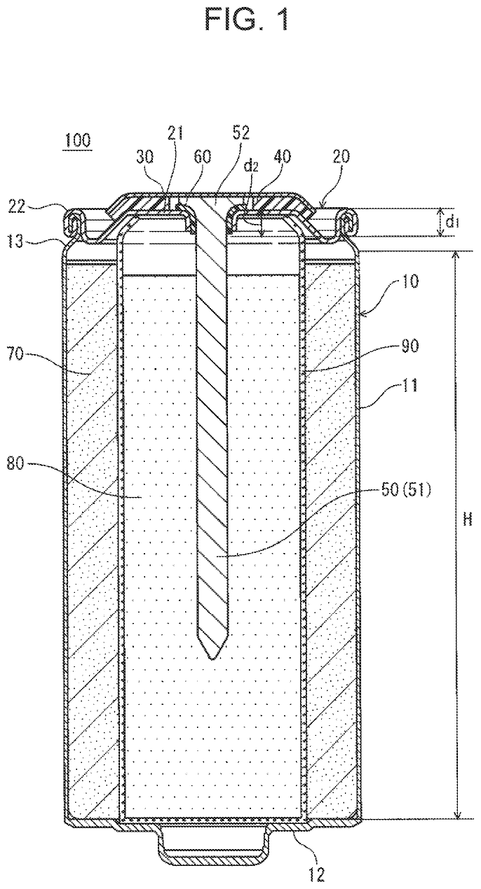

Next, a battery in accordance with an exemplary embodiment of the present invention is specifically described with reference to drawings, but the present invention is not limited to the below description. Furthermore, FIG. 1 shows a configuration of an alkaline dry battery as an example of the battery in accordance with this exemplary embodiment, but types of the battery are not limited to an alkaline dry battery. The present invention can be applied to various primary batteries and secondary batteries, for example, various types of dry batteries, a nickel hydrogen battery, a nickel cadmium battery, a lithium primary battery, a lithium secondary battery, a lithium ion battery, and the like.

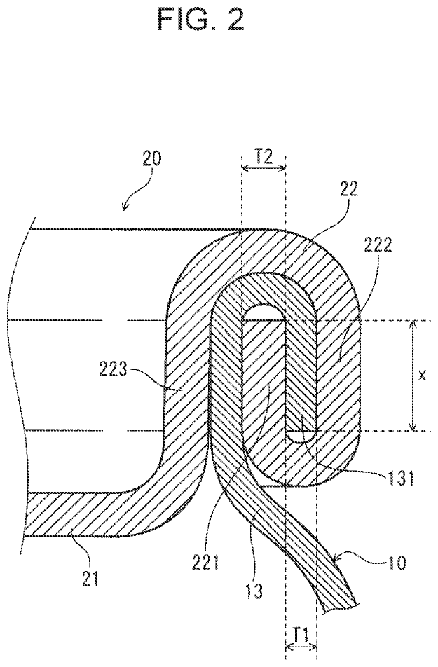

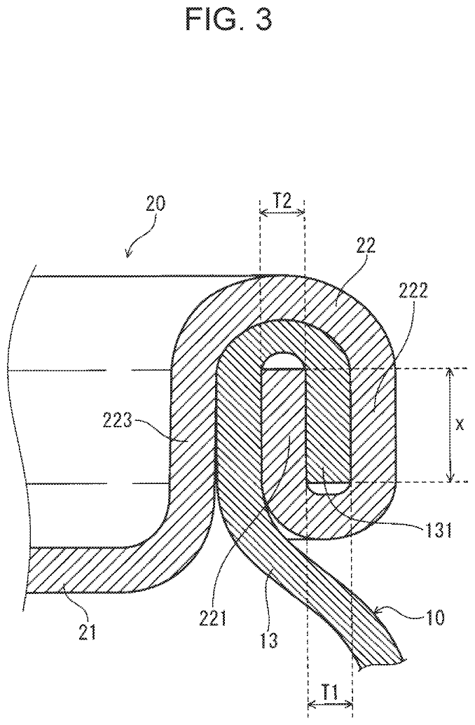

FIG. 1 is a schematic longitudinal sectional view of alkaline dry battery 100 having a double seaming structure in accordance with this exemplary embodiment. FIG. 2 is a view to illustrate the double seaming structure of a sealing part of battery 100, in which the relation formulae (1.) to (4) are satisfied. On the other hand, FIG. 3 shows a double seaming structure of a sealing part of another battery, in which T1=T2 is satisfied, and at least the relation formula (3): 1.1≤T2/T1≤3.0 is not satisfied.

In FIG. 1, battery 1.00 includes battery can 10 having a cylindrical shape and having a bottom, a power generation element housed in battery can 10, and sealing plate 20 for sealing battery can 10. Battery can 10 includes cylinder portion 11 housing the power generation element, bottom wall 12 for closing a first end of cylinder portion 11, and opening edge 13 continuous to a second end of cylinder portion 11. Sealing plate 20 is fixed to opening edge 13 so as to seal the opening. Sealing plate 20 includes lid portion 21 including a central region, and peripheral edge portion 22 continuous to lid portion 21.

The power generation element includes positive electrode 70 having a hollow cylindrical shape, negative electrode 80 disposed inside the hollow of positive electrode 70, separator 90 disposed between positive electrode 70 and negative electrode 80, and an alkaline electrolytic solution (not shown), and these are housed inside battery can 10 serving as a positive electrode terminal.

Positive electrode 70 is obtained by compression-molding a positive electrode material mixture containing, for example, a positive electrode active material, a conductive agent, and an alkaline electrolytic solution into a pellet shape. For the positive electrode active material, manganese dioxide, and the like, is used. For the conductive agent, carbon black, graphite, and the like, are used. Negative electrode 80 is, for example, a mixture of a negative electrode active material, a gelling agent, and an alkaline electrolytic solution, For the negative electrode active material, powdery zinc, powdery zinc alloy, and the like, are used. For the gelling agent, a water absorbing polymer and the like is used. For separator 90, a sheet mainly mixing a cellulose fiber and a polyvinyl alcohol fiber, and the like, is used. Separator may be made of one sheet, or may be made by stacking a plurality of sheets. As the alkaline electrolytic solution, for example, an alkaline aqueous solution containing potassium hydroxide is used. The alkaline aqueous solution can further contain zinc oxide.

In FIG. 1, sealing plate 20 forms a sealing unit together with negative electrode terminal plate 30 covering lid portion 21, insulating member 40, negative electrode current collector 50, and gasket 60. Negative electrode current collector 50 has a nail shape including body portion 51 and head portion 52. Body portion 51 penetrates through sealing plate 20 and is inserted into negative electrode 80. Head portion 52 is welded to a middle portion of the inner surface of negative electrode terminal plate 30. Since sealing plate 20 can have positive electrode property, insulating member 40 is interposed to electrically insulate between sealing plate 20 and negative electrode terminal plate 30. Gasket 60 is interposed to electrically insulate between the peripheral portion of the through-hole of sealing plate 20 and negative electrode current collector 50. A distance d1 between the upper end and the lower end of the double seaming structure is sufficiently smaller than that of a beverage can, and the like. The distance d1 is 3.0% or less of the height H of the cylinder portion of the battery can. Furthermore, the uppermost portion of lid portion 21 is positioned closer to the top with respect to the lower end of the double winding structure. Note here that in the beverage can, the uppermost portion of the lid portion is usually positioned closer to the bottom with respect to the lower end of the double winding structure.
For materials of battery can 10 and sealing plate 20, for example, a nickel plated steel plate or stainless steel can be used. In order to improve the adhesion between battery can 10 and positive electrode 70, a carbon coating film may be provided on the inner surface of battery can 10. For the negative electrode current collector, for example, brass, or the like, is used.

As shown in FIG. 2, in the double seaming structure, cover hook 221 formed of the outermost peripheral portion of peripheral edge portion 22 of sealing plate 20, and body hook 131 formed of the extreme end of opening edge 13 of battery can 10 are engaged with each other. That is to say, overlap length X of body hook 131 and cover hook 221 means the length of these mutual engagement.

In peripheral edge portion 22 of sealing plate 20, an outermost wall continuing to cover hook 221 is referred to as seaming wall 222, and the innermost wall continuing to seaming wall 222 is referred to as chuck wall 223. As it will be described later, seaming wall 222 is a site that is brought into contact with a tool referred to as a seaming roll in double seaming processing. Chuck wall 223 is a site that is brought into contact with a tool referred to as seaming chuck in the double seaming processing.

In the case of FIG. 3, since relation formula (3) is not satisfied, when the sealing part receives an impact, opening edge 13 of battery can 10 cannot sufficiently relieve the impact, and thus the sealing part is easily deformed Furthermore, in the case of T1≤T2, the distance between the inside surface of seaming wall 222 and the outside surface of chuck wall 223 is increased, so that, micro gaps easily occur. As a result, it becomes also difficult to increase the air-tightness of the battery.

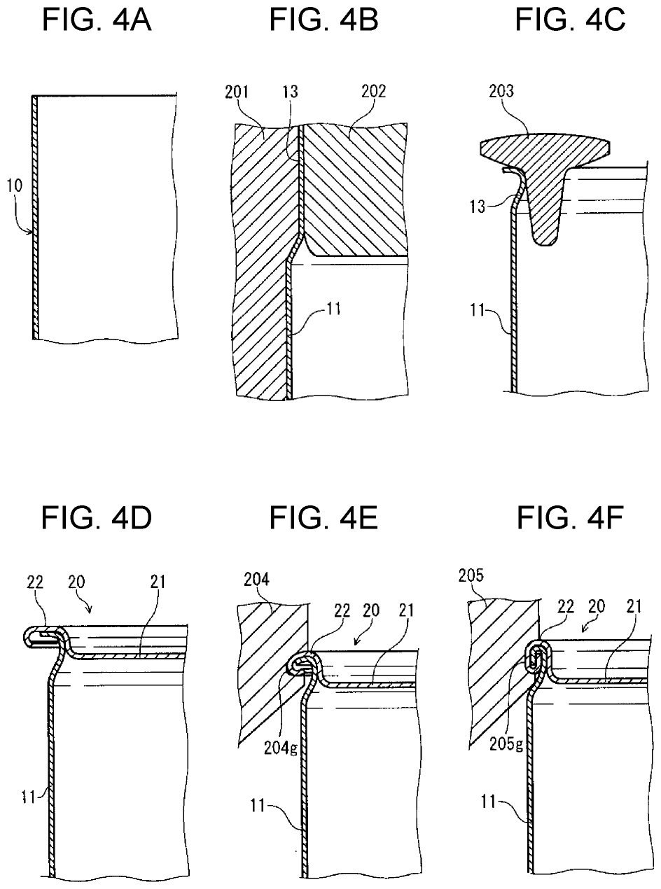

Next, with reference to FIGS. 4(a) to 4(f), an example of double seaming processing is described. The double seaming processing usually has two stages of seaming steps.

(a) Battery Can Preparation Step

Firstly, battery can 10 filled with a power generation element is prepared. In FIGS. 4(a) to 4(f), the power generation element is not shown. Battery can 10 is a can made of metal and having a bottom. An initial opening edge before necking and flanging are performed has an inner diameter and an outer diameter similar to those of the cylinder portion.

(b) Necking Step

In the necking step, the inner diameter and the outer diameter of opening edge 13 of battery can 10 are reduced. The necking step may be performed by any methods, but as shown in FIG. 4(b), the necking step can be performed by using necking die 201 having a cylinder shape whose inner diameter is reduced in the middle, and punch 202 having an outer diameter corresponding to the inner diameter of opening edge 13 after the diameter is reduced.

(c) Flanging Step

Next, the extreme end of opening edge 13 is expanded outward so as to form a flange. The flanging step may be performed by any methods, but as shown in FIG. 4(c), the flanging step can be performed, by pressing flanging die 203 whose curved surface with a large curvature as the diameter gradually increases, against the inner side of opening edge 13 while flanging die 203 is rotated. At this time, battery can 10 may be rotated together with flanging the 203.

(d) Sealing Plate Disposing Step

Next, sealing plate 20 is mounted on opening edge 13 having a flange. Sealing plate 20 has been press-molded into a shape of a shallow cup. The bottom portion of the cup corresponds to lid portion 21 of sealing plate 20. Peripheral edge portion 22 of sealing plate 20 is processed into a flange shape that is sufficiently larger than the flange of battery can 10, and the outermost peripheral portion is largely bent toward the bottom portion.

(e) First Seaming Step

A first seaming step is a step of changing shapes of opening edge 13 of battery can 10 and peripheral edge portion 22 of sealing plate 20 and winding the outermost peripheral portion of peripheral edge portion 22 as cover hook 221 to the inner side of the extreme end of opening edge 13 as body hook 131. In the first seaming step, lid portion 21 of sealing plate 20 is fixed by a seaming chuck (not shown) as a cylinder rotor, while first seaming roll 204 is pressed against the outer side of a bent surface of peripheral edge portion 22. First seaming roll 204 is a cylinder rotor having first groove 204g on the circumferential surface along the circumferential surface. First groove 204g has an inner surface that is a curved surface. The shapes of opening edge 13 of battery can 10 and peripheral edge portion 22 of sealing plate 20 are changed along the curved surface of first groove 204g, and the inner surface of peripheral edge portion 22 and the outer surface of the opening edge 13 appropriately adhere to each other.

(f) Second Seaming Step

Following to the first seaming step, a second seaming step is a step of further changing the shapes of opening edge 13 of battery can 10 and peripheral edge portion 22 of sealing plate 20, and tightening body hook 131 and cover hook 221 to each other. In the second seaming step, while lid portion 21 of sealing plate 20 is fixed by a seaming chuck, second seaming roll 205 is pressed against the outer side of the bent surface of peripheral edge portion 22. Second seaming roll 205 is a cylinder rotor having second groove 205g on the circumferential surface along the circumferential surface. Second groove 205g has an inner bottom surface that is substantially flat. The shapes of opening edge 13 of battery can 10 and peripheral edge portion 22 of sealing plate 20 are changed into a substantially flat shape along second groove 205g, and a hermetically sealed sealing part is formed.

Hereinafter, the present invention is described specifically based on Examples and Comparative Examples, but the present invention is not necessarily limited to the following Examples.

### EXAMPLES 1 to 19 and COMPARATIVE EXAMPLES 1 to 25

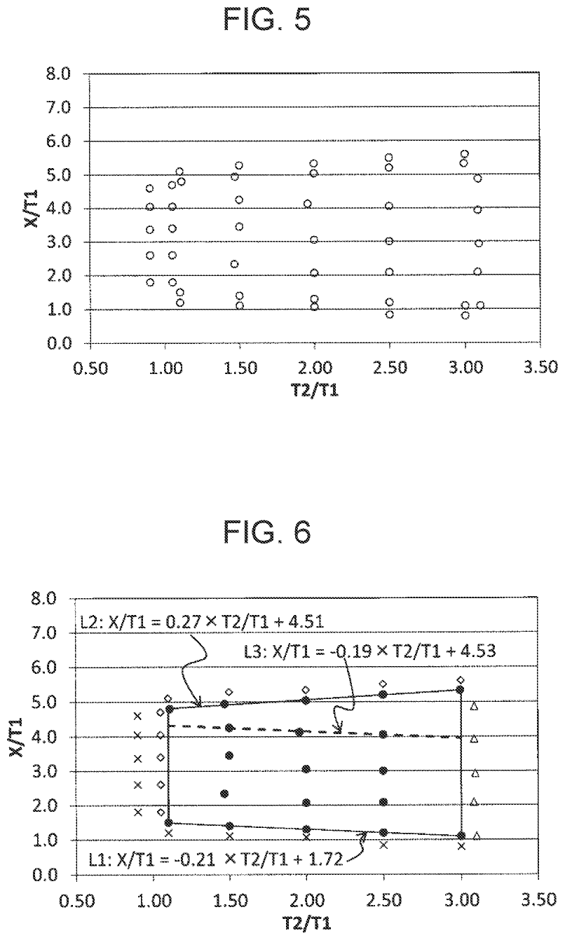

Cylindrical alkaline dry batteries having various sizes were produced according to the following procedures (1) to (3). Thickness T1 of a body hook of a battery can of each of the produced batteries, thickness T2 of a cover hook of a sealing plate, a T2/T1 ratio, an outer diameter D of each battery, an overlap length X (mm) of the body hook and the cover hook, an X/T1 ratio, and (T1+T2)/D (shown by percentage) are shown in Table 1. Furthermore, the relation between the T2/T1 and X/T1 is plotted by marker o in FIG. 5.

TABLE 1

| | | | | | | | | | Evaluation results | |
|---|---|---|---|---|---|---|---|---|---|---|
| | | | | | | | | Battery density | | Liquid |
| | D | T1 | T2 | T2/T1 | X | X/T1 | (T1 + T2)/D | g/cm³ | Deformation | leakage |
| B1 | 7.5 | 0.10 | 0.11 | 1.05 | 0.18 | 1.8 | 2.7% | 3.6 | 1/10 | 0/10 |
| B2 | 14.0 | 0.20 | 0.21 | 1.05 | 0.52 | 2.6 | 2.9% | 3.4 | 1/10 | 0/10 |
| B3 | 20.0 | 0.30 | 0.32 | 1.05 | 1.02 | 3.4 | 3.1% | 2.7 | 2/10 | 0/10 |
| B4 | 33.0 | 0.40 | 0.42 | 1.05 | 1.62 | 4.1 | 2.5% | 2.5 | 2/10 | 0/10 |
| B5 | 62.0 | 0.50 | 0.53 | 1.05 | 2.35 | 4.7 | 1.7% | 3.0 | 3/10 | 0/10 |
| B6 | 7.5 | 0.10 | 0.09 | 0.90 | 0.18 | 1.8 | 2.5% | 2.5 | 2/10 | 2/10 |
| B7 | 14.0 | 0.20 | 0.18 | 0.90 | 0.52 | 2.6 | 2.7% | 3.4 | 3/10 | 2/10 |
| B8 | 20.0 | 0.30 | 0.27 | 0.90 | 1.01 | 3.4 | 2.9% | 2.7 | 3/10 | 3/10 |
| B9 | 33.0 | 0.40 | 0.36 | 0.90 | 1.62 | 4.1 | 2.3% | 2.5 | 3/10 | 3/10 |
| B10 | 62.0 | 0.50 | 0.45 | 0.90 | 2.30 | 4.6 | 1.5% | 3.0 | 4/10 | 2/10 |
| B11 | 20.0 | 0.20 | 0.22 | 1.10 | 0.24 | 1.2 | 2.1% | 2.7 | 0/10 | 3/10 |
| B12 | 20.0 | 0.18 | 0.27 | 1.50 | 0.20 | 1.1 | 2.3% | 2.7 | 0/10 | 2/10 |
| B13 | 20.0 | 0.15 | 0.30 | 2.00 | 0.16 | 1.1 | 2.3% | 2.7 | 0/10 | 3/10 |
| B14 | 20.0 | 0.12 | 0.30 | 2.50 | 0.10 | 0.8 | 2.1% | 2.7 | 0/10 | 2/10 |
| B15 | 20.0 | 0.10 | 0.30 | 3.00 | 0.08 | 0.8 | 2.0% | 2.7 | 0/10 | 2/10 |
| B16 | 7.5 | 0.10 | 0.31 | 3.10 | 0.11 | 1.1 | 5.5% | 3.6 | Not performed | |
| B17 | 14.0 | 0.12 | 0.37 | 3.08 | 0.25 | 2.1 | 3.5% | 3.4 | Not performed | |
| B18 | 20.0 | 0.13 | 0.40 | 3.09 | 0.38 | 2.9 | 2.7% | 2.7 | Not performed | |
| B19 | 33.0 | 0.14 | 0.43 | 3.09 | 0.55 | 3.9 | 1.7% | 2.5 | Not performed | |
| B20 | 62.0 | 0.15 | 0.46 | 3.09 | 0.73 | 4.9 | 1.0% | 3.0 | Not performed | |
| B21 | 20.0 | 0.20 | 0.22 | 1.10 | 1.02 | 5.1 | 2.1% | 2.7 | 2/10 | 0/10 |
| B22 | 20.0 | 0.18 | 0.27 | 1.50 | 0.95 | 5.3 | 2.3% | 2.7 | 2/10 | 0/10 |
| B23 | 20.0 | 0.15 | 0.30 | 2.00 | 0.80 | 5.3 | 2.3% | 2.7 | 2/10 | 0/10 |
| B24 | 20.0 | 0.12 | 0.30 | 2.50 | 0.66 | 5.5 | 2.1% | 2.7 | 1/10 | 0/10 |
| B25 | 20.0 | 0.10 | 0.30 | 3.00 | 0.56 | 5.6 | 2.0% | 2.7 | 1/10 | 0/10 |
| A1 | 7.5 | 0.10 | 0.11 | 1.10 | 0.15 | 1.5 | 2.8% | 3.6 | 0/10 | 0/10 |
| A2 | 7.5 | 0.10 | 0.15 | 1.50 | 0.14 | 1.4 | 3.3% | 3.6 | 0/10 | 0/10 |
| A3 | 7.5 | 0.10 | 0.20 | 2.00 | 0.13 | 1.3 | 4.0% | 3.6 | 0/10 | 0/10 |
| A4 | 7.5 | 0.10 | 0.25 | 2.50 | 0.12 | 1.2 | 4.7% | 3.6 | 0/10 | 0/10 |
| A5 | 7.5 | 0.10 | 0.30 | 3.00 | 0.11 | 1.1 | 5.3% | 3.6 | 0/10 | 0/10 |
| A6 | 14.0 | 0.15 | 0.22 | 1.47 | 0.35 | 2.3 | 2.6% | 3.4 | 0/10 | 0/10 |
| A7 | 14.0 | 0.15 | 0.30 | 2.00 | 0.31 | 2.1 | 3.2% | 3.4 | 0/10 | 0/10 |
| A8 | 14.0 | 0.12 | 0.30 | 2.50 | 0.25 | 2.1 | 3.0% | 3.4 | 0/10 | 0/10 |
| A9 | 20.0 | 0.20 | 0.30 | 1.50 | 0.69 | 3.5 | 2.5% | 2.7 | 0/10 | 0/10 |
| A10 | 20.0 | 0.20 | 0.40 | 2.00 | 0.61 | 3.1 | 3.0% | 2.7 | 0/10 | 0/10 |
| A11 | 20.0 | 0.20 | 0.50 | 2.50 | 0.60 | 3.0 | 3.5% | 2.7 | 0/10 | 0/10 |
| A12 | 33.0 | 0.30 | 0.45 | 1.50 | 1.28 | 4.3 | 2.3% | 2.5 | 0/10 | 0/10 |
| A13 | 33.0 | 0.23 | 0.45 | 1.96 | 0.95 | 4.1 | 2.1% | 2.5 | 0/10 | 0/10 |
| A14 | 33.0 | 0.18 | 0.45 | 2.50 | 0.73 | 4.1 | 1.9% | 2.5 | 0/10 | 0/10 |
| A15 | 62.0 | 0.45 | 0.50 | 1.11 | 2.16 | 4.8 | 1.5% | 3.0 | 0/10 | 0/10 |
| A16 | 62.0 | 0.34 | 0.50 | 1.47 | 1.68 | 4.9 | 1.4% | 3.0 | 0/10 | 0/10 |
| A17 | 62.0 | 0.25 | 0.50 | 2.00 | 1.26 | 5.0 | 1.2% | 3.0 | 0/10 | 0/10 |
| A18 | 62.0 | 0.20 | 0.50 | 2.50 | 1.04 | 5.2 | 1.1% | 3.0 | 0/10 | 0/10 |
| A19 | 62.0 | 0.17 | 0.50 | 2.99 | 0.89 | 5.3 | 1.1% | 3.0 | 0/10 | 0/10 |

(1) Production of Positive Electrode

Graphite powder (average particle diameter (D50): 8 μm) as a conductive agent was added to electrolytic manganese dioxide powder (average particle diameter (D50): 35 μm) as a positive electrode active material so as to obtain a mixture. The mass ratio of the electrolytic manganese dioxide powder to the graphite powder was 92.4:7.6. To the mixture, an electrolytic solution was added. The resultant mixture was sufficiently stirred, and then compression-molded into flakes to obtain a positive electrode material mixture. The mass ratio of the mixture to the electrolytic solution was set to 100:1.5. The electrolytic solution to be used was an alkaline aqueous solution including potassium hydroxide (concentration: 35% by mass) and zinc oxide (concentration: 2% by mass). Positive electrode material mixture in a flake shape was pulverized to obtain granules, and the resultant granules were press-molded into a predetermined hollow cylindrical shape. Thus, a produce a positive electrode pellet was produced.

(2) Production of Negative Electrode

Zinc alloy powder (average particle diameter (D50): 130 μm) as a negative electrode active material, the above-mentioned electrolytic solution, and a gelling agent were mixed with each other to obtain a gel-like negative electrode. The gelling agent to be used was a mixture of polyacrylic acid and sodium polyacrylate. A mass ratio of the negative electrode active material, the electrolytic solution, and the gelling agent was 100:50:1.

(3) Assembly of Alkaline Battery

A battery can having a cylindrical shape and having a bottom and made of a nickel-plated steel plate having a predetermined size was prepared, and a carbon coating film having a thickness of about 10 μm was formed on the inner surface of the battery can. Predetermined number of positive electrode pellets were inserted into the battery can, followed by being pressed to form a positive electrode in a state that adheres to the inner wall of the battery can. Next, the separator having a cylindrical shape and having a bottom. was disposed to the inner side of the positive electrode. Then, the above-mentioned electrolytic solution was poured, and the separator was impregnated with the electrolytic solution. This state was left for a predetermined time to infiltrate the electrolytic solution from the separator into the positive electrode. Thereafter, a predetermined amount of negative electrode was packed into the inner side of the separator.

Next, the battery can was subjected to necking and flanging steps, a sealing plate was disposed on the opening edge of the battery can, and the first and second seaming steps were performed to form a sealing part having a double seaming structure. Thus, an alkaline dry battery was completed.

Evaluation

Ten each of batteries A1 to A19 of Examples 1 to 19 and batteries B1 to B25 of Comparative Examples 1 to 25 were prepared, and subjected to evaluation of impact resistance. Herein, 10 each of the batteries were dropped onto the plastic tile from the height of 100 cm with the sealing parts thereof facing downward. At this time, the number of batteries in which deformation was found in the sealing part, and the number of batteries in which liquid leakage occurred were obtained in visual observation. Note here that in Comparative Examples 16 to 20, liquid leakage occurred in batteries after completion and before evaluation of impact resistance. Furthermore, the density of the battery was calculated by Archimedes method. Evaluation results are shown in Table 1.

Next, the relation between. T2/T1 and X/T1 is plotted with markers ⋅ for batteries in which neither deformation nor liquid leakage occurred in ten batteries, and the other cases are plotted with other markers in FIG. 6.

In FIG. 6, an approximate straight line L1 of the plots (⋅) of batteries A1, A2, A3; A4, and A5, an approximate straight line L2 of the plots (⋅) of batteries A15, A16, A17, A18, and A19, and an approximate straight line L3 of the plots (⋅) of batteries A12, A13, and A14 are represented by the following formulae, respectively. That is to say, batteries showing neither deformation nor liquid leakage and showing excellent impact resistance satisfy the relation formula (4): −0.21T2+1.72T1≤X≤0.27T2+4.51T1. Furthermore, batteries having the outer diameter D of 33 mm or less and having higher versatility satisfy the relation formula (5): −0.21T2+1.72T1≤X≤−0.19T2+4.53T1.

L1: X/T1=−0.21T2/T1+1.72

L2: X/T1=0.27T2/T1+4.51

L3: X/T1=−0.19T2/T1+4.53

On the other hand, in FIG. 6, batteries having higher possibility of occurrence of liquid leakage are plotted with marker x, batteries having higher susceptibility to deformation are plotted with marker ⋄, and batteries whose workability is largely deteriorated are potted with marker Δ.

### REFERENCE EXAMPLE 1

A battery was produced using a sealing unit for crimp-sealing, provided with a polyamid.e gasket. Firstly, a head. portion of a negative electrode current collector was electrically welded to a negative electrode terminal plate made of a nickel-plated steel plate. Thereafter, the body portion of the negative electrode current collector was press-fitted into the through-hole at the center of a gasket to produce a sealing unit including the gasket, a negative electrode terminal plate, and the negative electrode current collector.

The sealing unit was disposed at an opening of the battery can having an annular groove provided to the opening edge, and a body portion of the negative electrode current collector was inserted into the inside of the negative electrode. Next, the opening edge of the battery can was crimped to the peripheral edge portion of the negative electrode terminal plate via the gasket, and the opening edge of the battery can was sealed. Thus, an alkaline dry battery including a battery can having an outer diameter D of 14 mm and a thickness T3 of the cylinder portion of 0.2 mm was completed.

Ten batteries of Reference Example 1 were prepared, and subjected to evaluation of impact resistance in the same manner as mentioned above. Deformation was observed in one of ten batteries, and liquid leakage was observed in three of the ten batteries.

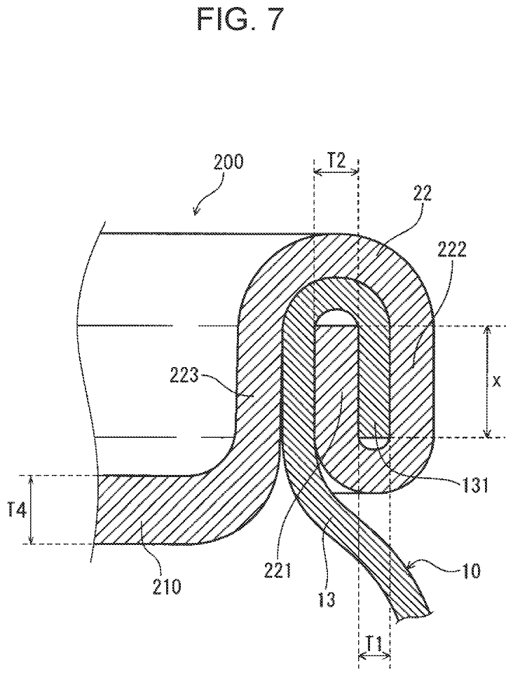

Next, a modified example of the present invention is described with reference to FIG. 7. FIG. 7 is a view to illustrate a double seaming structure of another exemplary embodiment of the present invention.

FIG. 7 is the same as FIG. 2 except for lid portion 210 of sealing plate 200. Thickness T4 of lid portion 210 is set to 1.2 times as thickness T2 of cover hook 221. When a sealing plate is formed in this way, strength of the battery itself is enhanced, and the impact resistance can be improved.

Thickness T4 of lid portion 210 that is larger than the thickness T2 of cover hook 221 may be sufficient. Specifically, T4 may be set to 1.2 to 2.5 times as T2. With consideration of workability of the sealing plate, T4 may be set to 1.5 to 2.0 times as T2.

### INDUSTRIAL APPLICABILITY

A battery according to the present invention has high impact resistance of a sealing part, and therefore, is suitable for power supply of, for example, portable devices, hybrid vehicles, electric vehicles, and the like.

### REFERENCE MARKS IN THE DRAWINGS

10 battery can
11 cylinder portion
12 bottom wall
13 opening edge
131 body hook
20, 200 sealing plate
21, 210 lid portion
22 peripheral edge portion
221 cover hook
222 seaming wall
223 chuck wall
30 negative electrode terminal plate
40 insulating member
50 negative electrode current collector
51 body portion
52 head portion
60 gasket
70 positive electrode
80 negative electrode
90 separator
100 battery
201 necking die
202 punch
203 flanging die
204 first seaming roll
205 second seaming roll

1. A battery comprising:
a battery can including a cylinder portion, a bottom wall closing a first end of the cylinder portion, and an opening edge continuous to a second end of the cylinder portion;
a power generation element housed in the cylinder portion; and
a sealing plate fixed to the opening edge and sealing an opening defined by the opening edge,
wherein the sealing plate includes a lid portion, and a peripheral edge portion continuous to the lid portion,
the opening edge and the peripheral edge portion are engaged to each other by a double seaming structure, and
the following relation formulae are satisfied:
0.1 mm≤T1≤0.5 mm (1)
0.1 min≤T2≤0.5 mm (2)
1.1≤T2/T1≤3.0 (3)
−0.21.T2+1.72T1≤X≤0.27T2+4.51T1 (4)
where X millimeter is an overlap length of a body hook of the opening edge and a cover hook of the peripheral edge portion in the double seaming structure, T1 is a thickness of the body hook, and T2 is a thickness of the cover hook.

2. The battery according to claim 1, wherein X, T1, and T2 satisfy the following relation formula:
−0.21.T2+1.72T1≤X≤−0.19T2+4.53T1 (5)

3. The battery according to claim 1, wherein a density of the battery is 1.5 g/cm³ or more.

4. The battery according to claim 1, wherein T1, T2, and an outer diameter D millimeter of the cylinder portion satisfy the following relation formula:
0.01≤(T1+T2)/D≤0.06 (6).
